(19) United States
(12) Patent Application Publication
(10) Pub. No.: US 2009/0092292 A1
(43) Pub. Date: Apr. 9, 2009

(54) Eye Scanner with Integrated Focus Distance Determination Mechanism

(76) Inventors: John F. CARVER, Palm City, FL (US); George William McClurg, Jensen Beach, FL (US); Adam Mark Will, Boynton Beach, FL (US); Douglas S. Hodges, Boynton Beach, FL (US); Dean John Fedele, Jupiter, FL (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/868,403

(22) Filed: Oct. 5, 2007

(51) Int. Cl. G06K 9/00

(52) U.S. Cl. 382/117

(57) ABSTRACT

A hand-held iris scanner, used for identifying individuals, has a visor mechanism connected to the main body of the scanner via a hinged attachment. The visor mechanism can be folded and locked into an extended position, wherein the free-floating end of the visor (that is, the non-hinged end) provides a contoured surface against which a user may place his or her forehead. By placing the forehead against the visor, the user automatically positions their eyes within a field of view of the scanner optics, and at a substantially optimum distance for correctly focused imaging by the scanner optical system. The visor mechanism may also be folded and locked into a second position wherein the bulk of the visor is substantially flush with the main body of the scanner, allowing for compact storage. An optional cap attachment on the visor provides a cover mechanism to protect the scanner optics when the scanner is not in use.

### BACKGROUND OF THE INVENTION

1. Field of the Invention

The present invention relates generally to the field of biometrics. The present invention relates more particularly to scanning devices used to identify persons or other living beings based on biometrics associated with the eye.

2. Background Art

Biometrics is a science involving the analysis of biological characteristics. Biometric imaging captures a measurable characteristic of a human being or other living organism, typically a mammal, for identity purposes. See, for example, Gary Roethenbaugh, Biometrics Explained, International Computer Security Association, Inc. (1998), pp. 1-34, which is incorporated herein by reference in its entirety.

Eye scanners are biometric imaging systems for acquiring images of the human eye or the eye of other mammals for identity purposes. Two common types of eye scanners are iris scanners and retinal scanners, each of which rely on the distinctive patterns of the human iris or retina, respectively, to distinguish one individual from another.

Optical elements of eye scanners need to be correctly aimed at the eye or eyes of a user, and further the optical elements need to be focused correctly on the physiological features of interest (such as the iris of the eye, the retina of the eye, etc.) to obtain quality images of these features. Additional requirements for effective scanning include ensuring that the eyes are shielded from ambient light which may interfere with effective image capture; and at the same time aligning the eyes of the user with illumination from the scanner, which is intended to illuminate the eyes for purposes of image capture.

Ensuring correct focus of an eye scanner on the physiological features of interest, and further insuring correct alignment, may involve correct translational positioning of optical components relative to an eye along a line of sight from the eye. If may further involve ensuring that the optical components are at a correct height relative to the eye or eyes of a user.

For example, one approach to a sensing system may employ variable optical elements, e.g., a mechanical focusing mechanism, which may in turn entail gears, rails, springs, internal hydraulics, or similar elements. Such mechanical focusing mechanisms based on translational movement may move or otherwise adjust lenses or other optics to move closer or further from an eye along the line of sight of the eye to bring to bring features of interest to an in-focus condition. However, such focusing mechanisms introduce substantial mechanical complexity, along with a requirement that a determination be made via some means or mechanism to ascertain when the desired physiologic features of the eye are actually in focus. Such translational movement of optics further-from and closer-to the eye may also be cumbersome and undesirable for users.

Another possible means of focusing and alignment is to enable the person being measured to move their head in relation to the scanning mechanism, until the eye is in the proper position for a good focus. However, this approach may require a dynamic determination to be made as to when the person's eyes are at the proper distance from the scanning device, or at the proper height or correct angle relative to the scanner device. A further requirement is to provide visual indicators which signal to a person that he or she should move the head forward or backwards or in other directions, or keep the head at the current location.

Again, however, design complexity ensues; moreover such a system may also pose a challenge for some users who have difficulty following the visual cues which are intended to guide the position of their eyes or head. Such movement of a person closer to or further from an eye scanner may be awkward in many applications such as remote field use for hostile environments.

What is needed, then, is a mechanically and electrically simple means to ensure that a person's head, and in particular a person's eyes, are properly positioned in relation to an optical sensor in terms of distance and other related location vectors, in order to ensure proper focus by the sensor optics on the physiologic features of a person's eyes, with minimal scanner system complexity. What is further needed is a system which aligns the eyes of the user with scanner-generated lighting, while shielding the eyes from unwanted ambient lighting. What is further needed is a system and method which is simple, whose usage is straightforward for a typical or average user, and which is convenient for the user whose eyes are to be imaged via the optical scanning system.

### BRIEF SUMMARY OF THE INVENTION

The present invention solves the above-mentioned needs by providing an eye scanner with an attached visor. One end of the visor is attached to the main body of the scanner. The other end of the visor is contoured in shape so that the forehead of a person tends to fit into the contour of the visor. A person may place their forehead flush against the contoured end of the visor, and consequently the person's head and eyes may be in a position for measurements to be made of their eyes. In particular, the person's eyes may be within a field of view of the optical element of the scanner to allow the optical element to obtain an image of at least a portion of the eye.

In a further embodiment, the visor mechanism may be toggled into at least two different locked or fixed positions. In at least one of these fixed positions, the visor extends from the main body of the eye scanner in such a manner that a person may place their forehead against the free-floating end of the visor, and consequently be looking into the exterior optical elements of the scanner. The other fixed position may be a storage position of the visor.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

In the drawings, like reference numbers indicate identical or functionally similar elements. Further, and except where specifically noted otherwise, the drawing in which an element first appears is typically indicated by the leftmost digit(s) in the corresponding reference number (e.g., an element numbered 302 first appears in FIG. 3).

FIG. 1A is a drawing of a first view of an exemplary iris scanner showing some of the exterior elements, where the iris scanner does not have a visor.

FIG. 1B is a drawing of a second view of an exemplary iris scanner showing some of the optical and illumination elements of the scanner, where the iris scanner does not have a visor.

FIG. 2 is a drawing of a first view of an exemplary iris scanner, where the iris scanner has an exemplary visor.

FIG. 3 is a drawing of a second view of an exemplary iris scanner, where the iris scanner has an exemplary visor.

FIG. 4 is a drawing of a third view of an exemplary iris scanner, where the iris scanner has an exemplary visor.

FIG. 5 is a drawing of a fourth view of an exemplary iris scanner, where the iris scanner has an exemplary visor.

FIG. 6A is a drawing of an exemplary iris scanner with an exemplary scanner visor extended into a open position, and with the head of an exemplary user of the scanner positioned at a distance from the scanner which is not the correct distance for optimum scanning.

FIG. 6B is a drawing of an exemplary iris scanner with an exemplary scanner visor extended into a open position, and with the head of an exemplary user of the scanner properly positioned against an exemplary forehead receiving edge of the visor.

FIG. 7 is a series of images representing an exemplary visor being folded from an open position to a closed position, or vice-versa.

FIG. 8a is an exploded view of exemplary hinges connecting an exemplary iris scanner visor to an exemplary iris scanner housing.

FIG. 8b is a detailed view of an exemplary joint of an exemplary hinge component on an exemplary iris scanner housing.

FIG. 9 is an exploded view of an exemplary hinge joining an exemplary visor cap with an exemplary iris scanner visor.

The features, objects, and advantages of the present invention will become more apparent from the detailed description set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION OF EMBODIMENTS

I. Overview

II. Exemplary Scanner

III. Exemplary Scanner With Visor

IV. Exemplary Usage

V. Exemplary Joints and Hinges

VI. Exemplary Visor Cap Hinge

VII. Further Embodiments

VIII. Conclusion

### I. Overview

Embodiments of the present invention provide a scanner suitable for scanning the eye or eyes of a person. A suitable, approximately fixed relative position between the scanner optics and the person's eyes, as well as a suitable orientation between the scanner and the person's head, may be established by means of a rigid or substantially rigid visor which extends from the main body of the scanner. In particular, a suitable distance between the scanner optics and the person's eyes may be established by means of the rigid or substantially rigid visor which extends from the main body of the scanner. The suitable position, orientation, and/or distance of the person's eye or eyes and head in relation to the scanner optics ensures that at least a portion of the person's eye or eyes are within the field of view of the scanner optics. This enables the scanner optics to obtain an image of at least a portion of the person's eye or eyes.

Exemplary embodiments are described in terms of exemplary iris scanners, which may be used for identifying persons based on features of a person's iris. However, the present invention may equally well be employed in the context of other eye scanning devices which may scan, for example and without limitation, the human retina or the pattern of blood vessels of the choroid (which may be visible through the sclera).

Embodiments illustrated herein may be portable eye scanners, and may further be handheld eye scanners, but the present invention is not limited to such devices. It will be apparent to persons skilled in the relevant arts that the present system and method may apply equally to non-portable eye scanners and to eye scanners which are held in place in relation to a person's head and/or eyes by means other than being held in the person's hands.

For brevity, this document sometimes uses the singular term “eye”, or the plural term “eyes”, where it may be understood that either the singular term “eye”, the plural term “eyes”, or both may be applicable, depending on particular configurations of particular embodiments of the present invention.

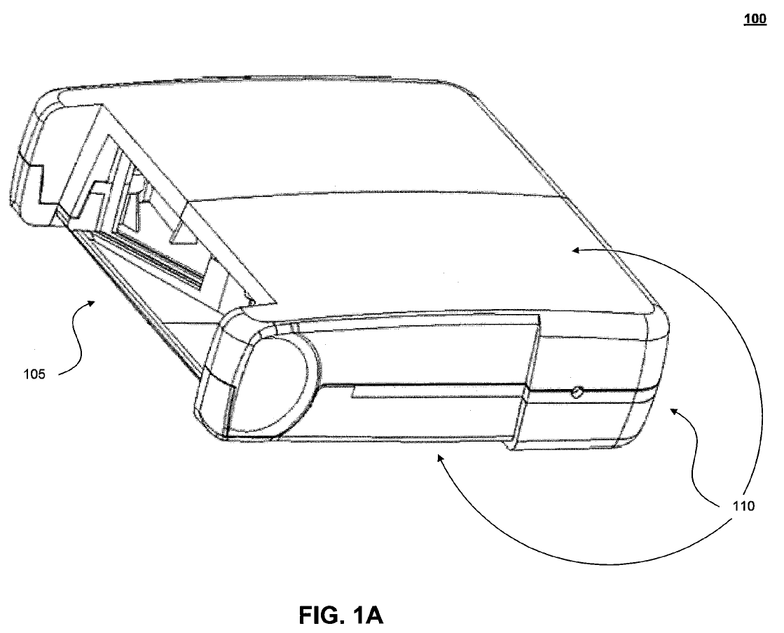

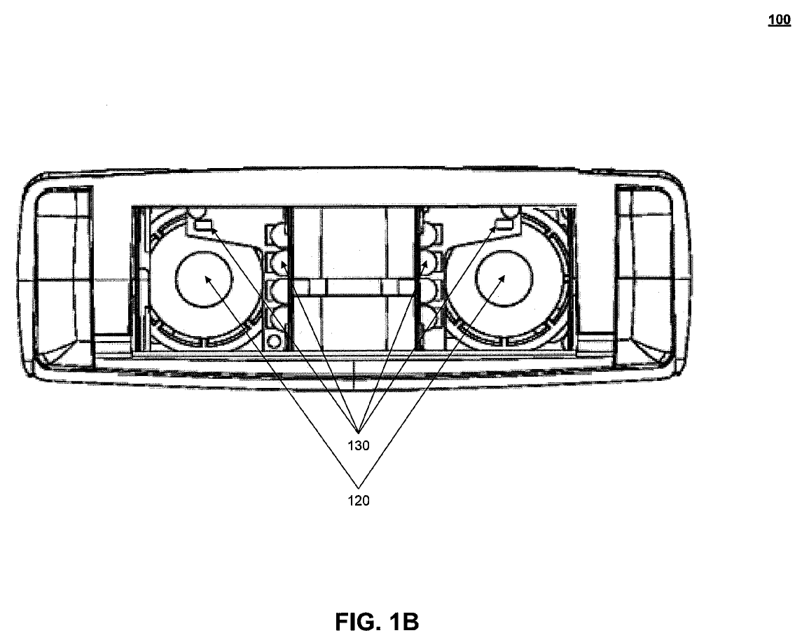

For purposes of background information, FIG. 1A and FIG. 1B pertain to illustrating elements of an exemplary iris scanner.

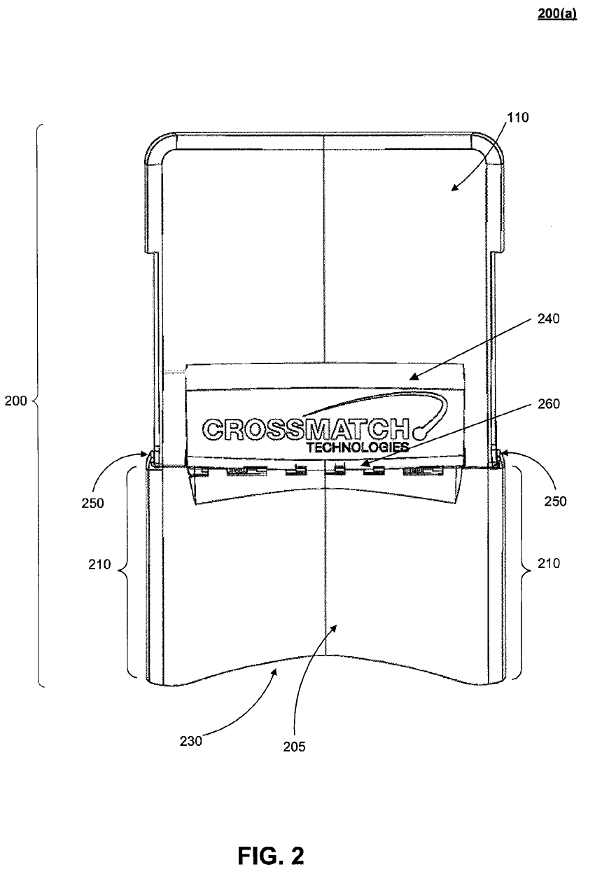

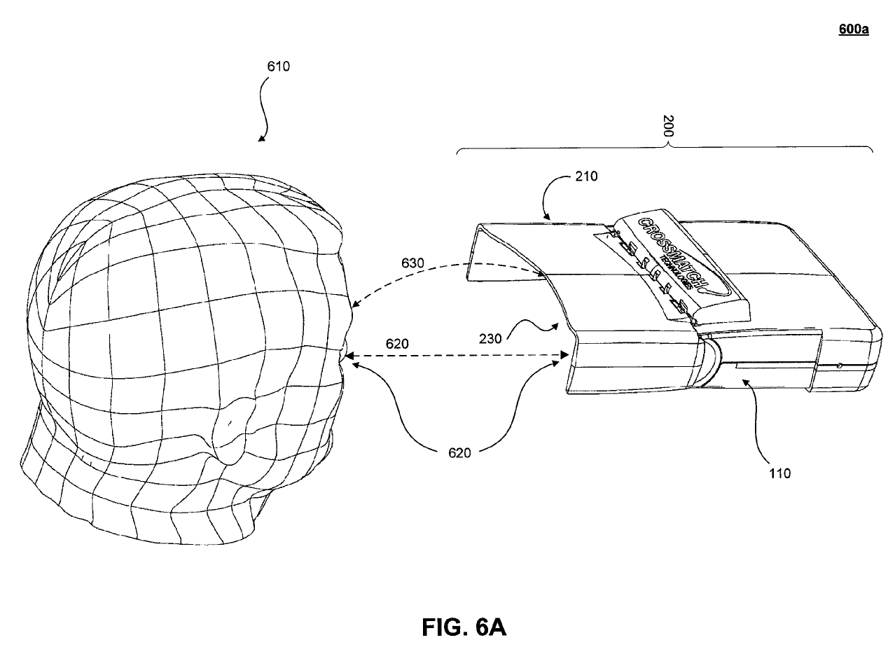

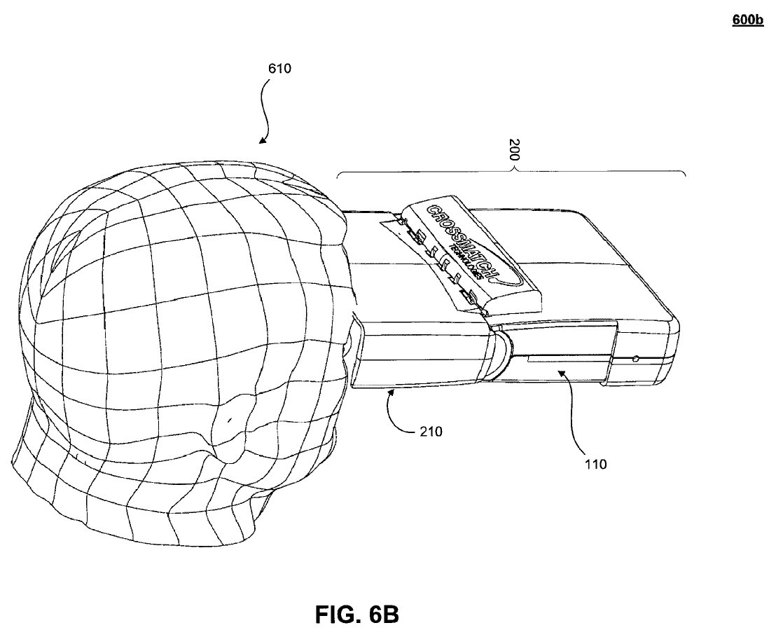

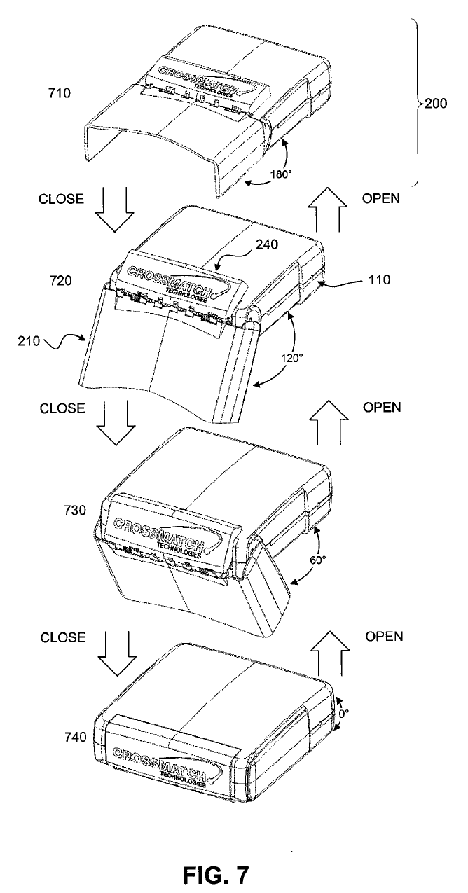

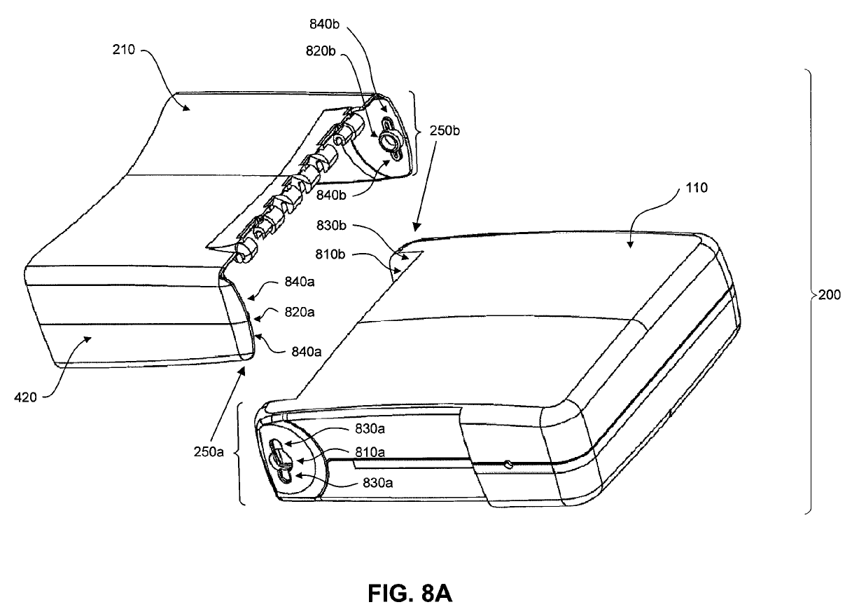

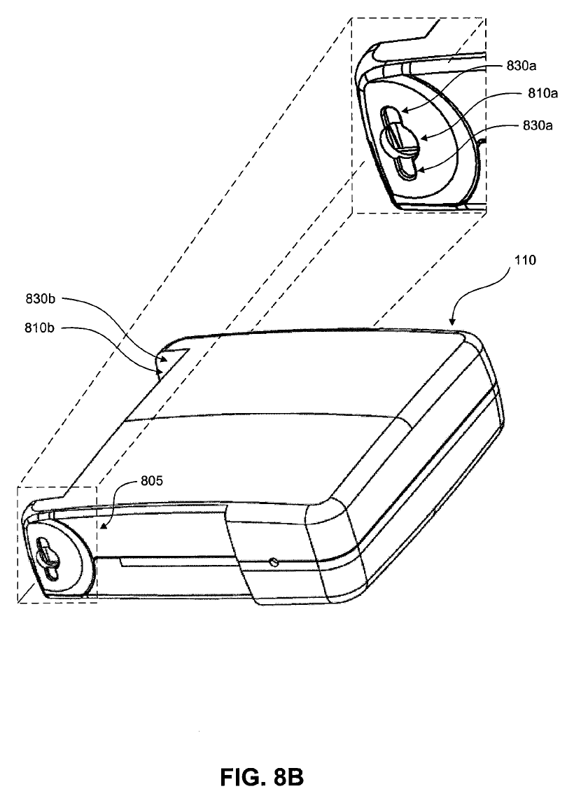

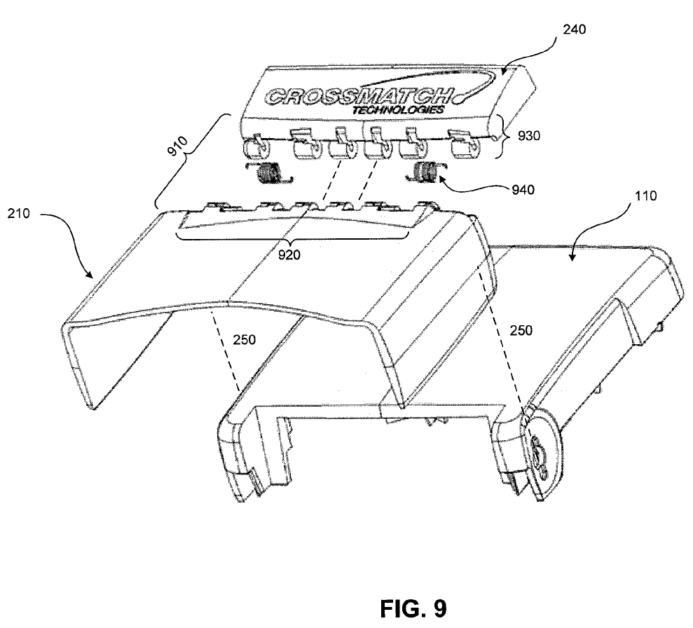

FIG. 2 through FIG. 9 pertain to illustrating aspects of exemplary embodiments of the present invention. In particular, FIG. 2 through FIG. 5 pertain to illustrating elements and features of an exemplary iris scanner with a visor. FIG. 6A, FIG. 6B, and FIG. 7 pertain to illustrating an exemplary usage of an exemplary iris scanner by an exemplary user, and to illustrating how an exemplary visor of an exemplary iris scanner may be opened and closed. FIG. 8A, FIG. 8B, and FIG. 9 pertain to illustrating exemplary hinge and joint elements and an exemplary cap of an exemplary scanner with visor.

### II. Exemplary Scanner

FIG. 1A is a drawing of a view of an exemplary iris scanner 100 showing some of the exterior elements, where the iris scanner does not have a visor. Scanner 100 may include a main scanner outer casing 110, which may also be referred to synonymously as the scanner main housing 110, the main scanner body 110, or simply as scanner housing 110. Scanner housing 110 may be used by a person to hold the scanner. Scanner housing 110 may also contain internally, and be used to internally anchor or fix in place, some or all of the main functional elements of scanner 100.

In one embodiment of the present system and method, scanner housing 110 may be approximately cuboid in shape (that is, having a shape which is approximately a rectangular parallelepiped), with three pairs of facing, approximately planar surfaces, defining a substantially closed scanner housing 110, wherein for any given pair of facing planar surfaces a first planar surface of the pair may be substantially or approximately parallel to a second approximately planar surface of the same given pair. Each pair of the three pairs of facing approximately planar surfaces may be substantially or approximately orthogonal to each of the other two pairs of facing approximately planar surfaces.

In alternative embodiments of the present system and method, scanner housing 110 may have other shapes including, for example and without limitation, approximately ellipsoid, approximately triangular, approximately cylindrical, and approximately pyramidal. Other shapes are possible as well within the scope and spirit of the present system and method. While scanner housing 110 is discussed and illustrated throughout this document as having an approximately cuboid shape for purposes of presenting embodiments of the present system and method, scanner housing 110 is not limited to an approximately cuboid shape.

Scanner 100 may have a front 105 or front side 105, where front 105 may typically be a side of scanner 100 which is configured to admit light to optics and/or imaging elements (described further below) for use in obtaining an image of at least a portion of an eye. It may therefore be desirable, when scanner 100 is in use, that a user position their eyes to be within a field of view of scanner 100 optics by positioning their eyes to be looking into front 105 of scanner 100. (In conjunction with this, see also FIG. 6A and FIG. 6B and related discussion, below.)

Scanner 100 may have a translucent (that is, clear) or semitranslucent covering (not illustrated) over front side 105. Such a covering may be composed of a material or materials such as glass, Plexiglas, plastic, or other translucent or semitranslucent materials. Such a covering may serve to provide protection to interior optics or imaging elements, interior illumination elements, and other interior components of scanner 100, while still permitting the passage of light in one or both directions through the covering. In addition to the covering, a seal or sealing material (not illustrated) bonding the cover to housing 110 may provide additional protection for the interior environment of scanner 100.

Further details of internal structures, features, and/or operations of scanner 100 are discussed throughout this application, and in particular in the discussion immediately below related to FIG. 1B and in the section below entitled “VII. Further Embodiments.”

FIG. 1B is another drawing of a view of an exemplary iris scanner 100 showing some of the scanner elements, where the iris scanner does not have a visor. In particular, FIG. 1B is a view which may be seen by a user whose eyes are at a level with scanner 100, and who is looking directly into front side 105 of scanner 100. Not shown or suggested by FIG. 1B is the translucent or semitranslucent covering and possible associated seal which may be present at front side 105 of scanner 100, as already discussed above.

Exemplary iris scanner 100 may include, for example situated within front side 105, a means for accepting an image of at least a portion of the human eye into the scanner. Such means may include, for example and without limitation, a simple opening which admits light which may be seen by interior optics of scanner 100, and lens or lenses 120 which may focus or help focus an image of the eye or eyes on an internal imaging element (not illustrated) contained within housing 110 of scanner 100. Exemplary iris scanner 100 may also provide illumination 130 which may be used for such purposes as illuminating the eye of a user, contracting the pupil or an eye of a user (and thereby enlarging the area of the iris available for imaging), or guiding the direction of sight of the eye of a user.

Illumination 130 may be direct illumination provided by a light bulb, laser light, LED, or similar light source. Illumination 130 may also be in the form of a diffuse illumination, whereby a means (not illustrated) of dispersing light is employed so that the source of illumination is not directly visible to a user of scanner 100. For example, a frosted piece of glass or plastic may be placed between a source of illumination and the eyes of the user, ensuring that the light which reaches the users eyes of diffused or softened. Other means to soften or diffuse the scanner illumination may be employed as well. This may make it possible to provide effective illumination for scanning the eyes of the user, while not drawing the user's line of sight directly to the source of illumination. It may be preferred, for example, that the user's line of sight is directed to the imaging optics, rather than the source of illumination.

It is to be understood, then, that at least some optical elements 120 and/or illumination elements 130 of scanner 100 as seen through front side 105 may be visible to a user of scanner 100, and may further directly receive light from the outside or directly transmit light to the outside to illuminate the eyes of a user. In this specific sense, such optics 120 and illumination 130 may be described herein as “exterior optics 120” or “exterior illumination 130”.

At the same time, there may be a translucent covering or semitranslucent covering over front side 105, as described above, and optics 120 and illumination 130 may be interior to scanner housing 110 in relation to such a cover. Further, optics 120 and illumination 130 may be recessed within scanner housing 110. Consequently, it is to be understood that while the terms “exterior optics 120” and “exterior illumination 130” may be employed herein for descriptive purposes as indicated above, optics 120 and illumination 130 may be structurally interior to scanner 100.

It is to be further understood that scanner 100 may employ additional optics and/or imaging systems, and possibly additional internal sources of illumination, which are not directly visible through front side 105, and which may receive or transmit light from the outside only indirectly (for example, via mirrors, lenses, prisms, fiber optics, or other elements which direct light along an interior path). Such elements may be referred to as “interior optics” or “interior illumination”. Where the terms “optics”, “optical systems”, “illumination”, “illumination elements” and similar terms are used without reference to “interior” or “exterior”, it will be apparent from context if the terms indicate exterior elements (as characterized above), interior elements, or possibly may indicate either interior elements, exterior elements, or both.

Exemplary iris scanner 100 may require that, in order to accurately identify a person based on characteristics of an iris or irises, the optical systems and/or imaging systems within scanner 100 should be able to obtain a substantially focused image of an iris or both irises of the person. It may also be necessary for the eye or eye's of the user to be properly aligned in relation to illumination elements. In turn, it may be necessary both that the person's eyes be within a field of view of scanner 100, and that the distance between the person's eyes and the exterior-most lenses 120 or other exterior optics 120 or light entry means of scanner 100 fall within a fairly narrow range, with that range centered around a specific, optimum distance. In particular, this may require that a person who is using scanner 100 position their eyes to be looking into front 105 of scanner 100, and further that the person have their eyes positioned at a suitable distance from front 105 of scanner 100. It may also be necessary that scanner 100 be at a suitable height relative to the eyes of a user, and that scanner 100 be suitable oriented in other respects in relation to the eyes and/or head of a user.

Put another way, for optimal scanning, and in particular for reliable and consistent biometric identification, it may be that the eyes of the person should be within a field of view of scanner 100, and in particular within a field of view of the optical system. In one example, an eye or eyes are positioned within a field of view at a distance that allows an image of at least a portion of an eye to be obtained by an optical system in scanner 100. For example, the eye position may be located at a distance corresponding to an “in-focus” condition, where the eye position is imaged by the optical system at a correct focal length.

Persons skilled in the relevant art(s) will appreciate that this “in-focus” distance may, in some embodiments, be on the order of a length of the scanner itself—for example, half the length of the scanner, or two-thirds of the length of the scanner, with the precise distance depending on the configuration of the optics and imaging elements housed within scanner housing 110.

Persons skilled in the relevant art(s) will further appreciate that, in terms of the distance of a person's eyes from the scanner when the scanner is in use, there may be some allowable minor variation in either direction from this substantially fixed optimal distance. Such allowance for small variations in distance may be necessary in the design of scanner 100 due to the fact that the eyes of different people may have a slightly different depth in relation to their foreheads, and possibly due to other physiological factors, and factors of other kinds.

Due to the lack of a visor on exemplary scanner 100, it may be difficult for a person using the scanner to place their eyes at the required distance from the exterior optics 120 of the scanner. Moreover, due to the lack of the visor, it may be difficult to align the person's eyes with the scanner optics 120, or to align the person's eyes with the scanner illumination 130, or both. Moreover, due to the lack of the visor, it may be difficult to shield both the person's eyes and the optical system of scanner 100 from ambient lighting. Finally, due to the lack of a visor and possibly an associated cap, it may be difficult to protect the scanner optics from degrading environmental factors such as moisture or dust when scanner 100 is not in use.

III. Exemplary Scanner with Visor

The following discussion discloses one or more embodiments of an exemplary iris scanner 200 consisting of an exemplary visor, which may also be referred to as a hood, which may be attached to an exemplary iris scanner housing 110 for multiple functional purposes including, for example and without limitation:
orientating a user's head and eyes so that the person's eyes are within a field of view of optics 120 of scanner 200, so that scanner 200 may obtain an image of at least a portion of an eye of the user;
establishing an appropriate distance between the eyes of the user and the scanner optics 120 and/or imaging system(s);
establishing a correct orientation between the eye or eyes of a user and the scanner optics 120 and/or imaging systems;
aligning the eye or eyes of a user with the scanner illumination element or elements 130, so that the eyes receive sufficient illumination to be imaged by the scanner optics 120; and
shielding either the human or the scanner 200, or both, from ambient lighting.

The discussion may disclose a visor configured for use with an iris scanner housing 110 which is substantially or approximately cuboid, as with scanner 100 discussed above in conjunction with FIG. 1A and FIG. 1B. However, persons skilled in the relevant arts will appreciate that a visor may be configured consistent with the present system and method which may be employed in conjunction with a main scanner body which may have a shape substantially different from a cuboid shape, while still enabling one or more of the functional purposes enumerated immediately above.

FIG. 2 shows a view 200(a) of an exemplary iris scanner 200. Iris scanner 200 includes housing 110. Housing 110 plus all components internal to housing 110, and further including any components embedded within scanner housing 110 (including, for example, various ports and connectors), but apart from a visor 210 which may be attached to housing 110, may comprise a main body of scanner 200.

Exemplary scanner 200 may be the same, substantially the same, or similar to exemplary iris scanner 100 (discussed above in conjunction with FIG. 1A and FIG. 1B) in terms of housing 110 and in terms of internal structure, function, and operations. Therefore, a discussion of housing 110 and the internal structural and functional features of exemplary iris scanner 200 which are analogous to those of exemplary scanner 100 will not be repeated here. However, exemplary iris scanner 200 may have an attached exemplary visor 210.

Exemplary iris scanner 200 may have a side which may be referred to as the top side, and which is the side of scanner 200 which would normally face the ceiling or sky when scanner 200 is held as it may be held for normal usage by a person standing upright. View 200(a) presents a top view of scanner 200, showing the top side of scanner 200, with exemplary visor 210 fully extended from scanner housing 110, a position that may also be referred to as the open position of visor 210.

The surface shown of exemplary visor 210 may be a top surface 205, which may help shield both the eyes of a user and the scanner optical elements 120 and lighting elements 130 from ambient lighting. Visor 210 may be viewed as serving both as a shield or shade from ambient lighting, and as a positioner or positioning element to properly position the head of a user in relation to scanner housing 110.

In embodiments illustrated throughout this document, visor 210 does not have a bottom side. Consequently, and in relation to such embodiments, the discussion here and elsewhere in this document of the application of exemplary visor 210 as a light shield typically assumes that ambient lighting comes from the sky, ceiling lights, or other light sources which are situated no lower than the height of the head of a person using scanner 200, as is typically the case. Visor 210 without a bottom side may not be effective or may be less effective at shielding against ambient light if the ambient light comes from a source which is at or below the height at which scanner 200 is itself used, which may be the same height as the height of the eyes of a user.

In an alternative embodiment of the present system and method, visor 210 may have a bottom side (not illustrated). Such embodiments are described further in the section of this document entitled “Section VII. Further Embodiments”.

Exemplary visor 210 may be joined to scanner housing 110 via joints 250 on either side of scanner housing 110, where the structural elements of joints 250 (discussed further below) may be partly hidden from view underneath the side panels of visor 210. A near end of visor 210, that is, the end closest to scanner housing 110, may be attached to the front side 105 of scanner housing 110, which contains exterior optical elements 120 (not visible in this view) which can accept within their field of view an image of a person's eye or eyes, as well as exterior illumination elements 130 (also not visible in this view) which illuminate the person's eye or eyes.

At the far end or distal end of visor 210, that is, the end most distant from scanner housing 110, visor 210 may be contoured with a curved contour 230 which substantially conforms to the curve of a forehead of a typical person. In this way, a typical person may place their forehead flush against contour 230 of visor 210, and in so doing may place their eyes within the field of view of scanner optical elements 120. Further, in placing their forehead flush against contour 230 of visor 210, the person may place their eyes at a distance from optical elements 120 which falls at or near the optimal range for scanning of the eyes by scanner 200.

Further, in placing their forehead flush against contour 230 of visor 210, the person may place their eyes so that their eyes are aligned in a substantially optimal position in relation to scanner illumination elements 130. In some embodiments of the present system and method, optimal alignment may be further achieved by indicating to a user a preferred height at which contour 230 of visor 210 should be placed, for example, immediately above the eyebrows, or approximately one inch above the eyebrows, etc. There may also exist a preferred angle at which the visor 210 and scanner 200 should be placed, for example, approximately level relative to the ground (assuming the user is sitting or standing upright). Other angles may be preferred instead.

Scanner 200 may also include a cap 240 which is attached to visor 210. Cap 240 may be an elongated element with a length and width substantially the same as the length and width of a side of scanner housing 110 which may be protected or covered by cap 240. Cap 240 may be flat, or may have a bulge or curvature creating a depth for cap 240. When visor 210 is in the open position, cap 240 may rest on a surface of scanner housing 110, which may for example be the top surface, where cap 240 does not hinder either scanner 200 operations or the activity of the user. Visor cap 240 may be attached to visor 210 via a visor cap hinge 260 which may be a spring-loaded visor cap hinge 260.

Both scanner housing 110 and visor 210 may be composed of a material or combination of materials such as plastic, various metals or metal alloys, various polymers, or various composite substances well known in the art. Such materials may be rigid enough to provide the necessary structural sturdiness for scanner housing 110 and visor 210 to operate properly (for example, to provide support for internal structural and functional components, or to establish a substantially fixed distance between the forehead of a user and the optical elements of the scanner); yet such materials may also have sufficient ability to bend or flex, that is, may have a sufficient elasticity, to support the operation of moving elements such as scanner body/visor joints 250.

The points of attachment of visor 210 to scanner housing 110, and in particular the location of joints 250, may be at the front 105 of scanner housing 110, where the front of scanner housing 110 may be defined, as per the discussion above, as being the side of scanner housing 110 where the exterior optics 120 and exterior illumination 130 of scanner 200 are located.

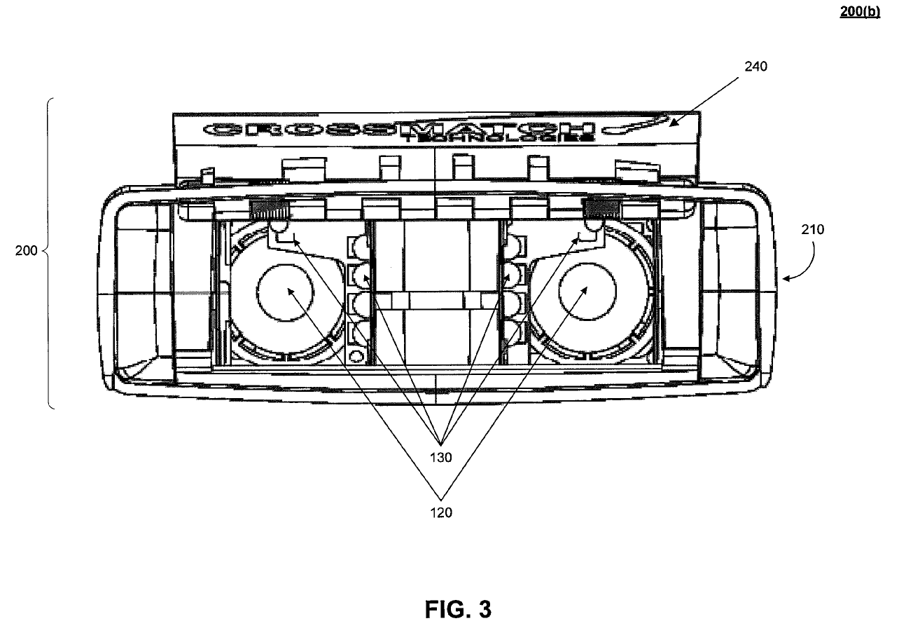

FIG. 3 shows a second view 200(b) of exemplary iris scanner 200 first seen in FIG. 2. View 200(b) shows exemplary iris scanner 200 from a head-on frontal view. This is a view which may be seen by a user of scanner 200, for example as the user is holding scanner 200 in hand at eye level, and as the user is moving scanner 200 towards their forehead but does not yet have scanner 200 flush against their forehead.

Seen in view 200(b) are the exterior optical or imaging elements 120 and exterior illumination elements 130 of scanner 200 as seen when looking into front 105. Also visible in this view is the front-most rim of visor 210, which may be seen in outline form only. It can be seen that with visor 210 in the open position, as shown, the user may have an unimpeded view of exterior optics 120 of scanner 200, and therefore exterior optics 120 may have an unimpeded view of the user's eyes. Put another way, it can be seen that with visor 210 in the open position, as shown, if the user looks into front 105 of scanner 200, then the eyes or a portion the eyes of the user may fall within a field of view of optics 120 of scanner 200. This enables scanner 200 to obtain an image of the user's eyes for purposes of biometric identification. Similarly, exterior illumination elements 130 may be optimally positioned to illuminate the eye or eyes of the user. Also visible in view 200(b) is the visor cap 240, which may lie flush against the top of scanner housing 110.

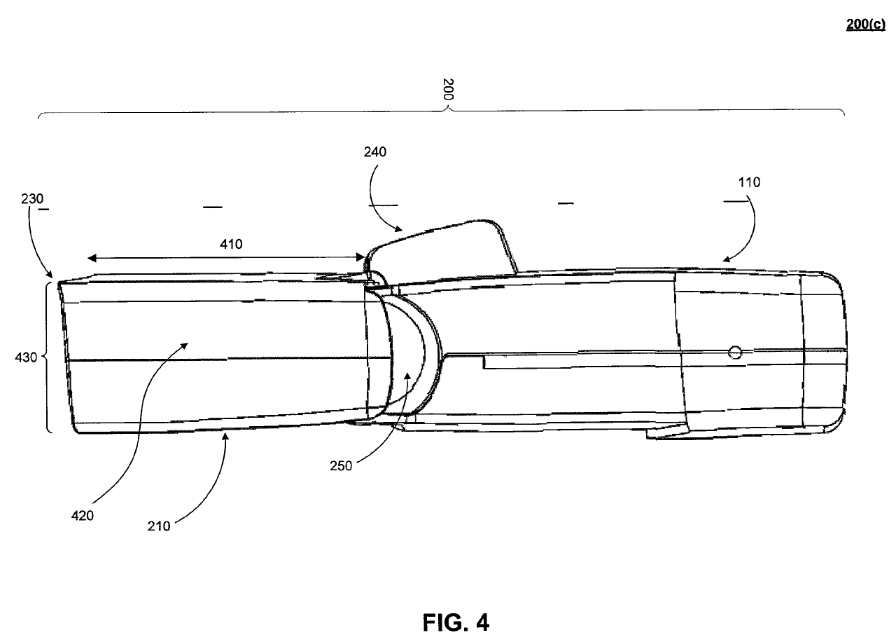

FIG. 4 shows a third view 200(c), which may be a side view, of exemplary iris scanner 200, also seen in FIG. 2 and FIG. 3 above. It may be seen that visor cap 240 may lie flush against a side of scanner housing 110, which may be the top side of scanner housing 110 as sensor 200 may be held by a user in normal usage. Visor 210 may have a joint element which may extend to cover part of joint 250 and may itself constitute a part of joint 250.

Visor 210 may have a length 410 which determines the distance between the front 230 of visor 210 and a front side 105 of scanner 200 which displays or reveals optical elements 120 to a user of scanner 200. In one embodiment, it may be that length 410 determines the fixed distance between the eyes of the user and the front 105 of scanner 200 which is the substantially optimal distance for effective and reliable eye scanning by scanner 200. In an alternative embodiment, it may be that length 410, in combination with or in addition with a distance from the front of scanner 200 to exterior optical elements 120, determines the fixed distance between the eyes of the user and optical elements 120 which is the substantially optimal distance for effective and reliable eye scanning by scanner 200.

It may be seen that visor 210 also has a side panel 420 which may extend substantially orthogonally from the top surface 205 of visor 210. Side panel 420 may help shield both the eyes of a user and the exterior scanner optical/lighting elements 120, 130 from ambient lighting. The front of visor side panel 420 may have a gentle contour 430 designed to match the temples of a human user.

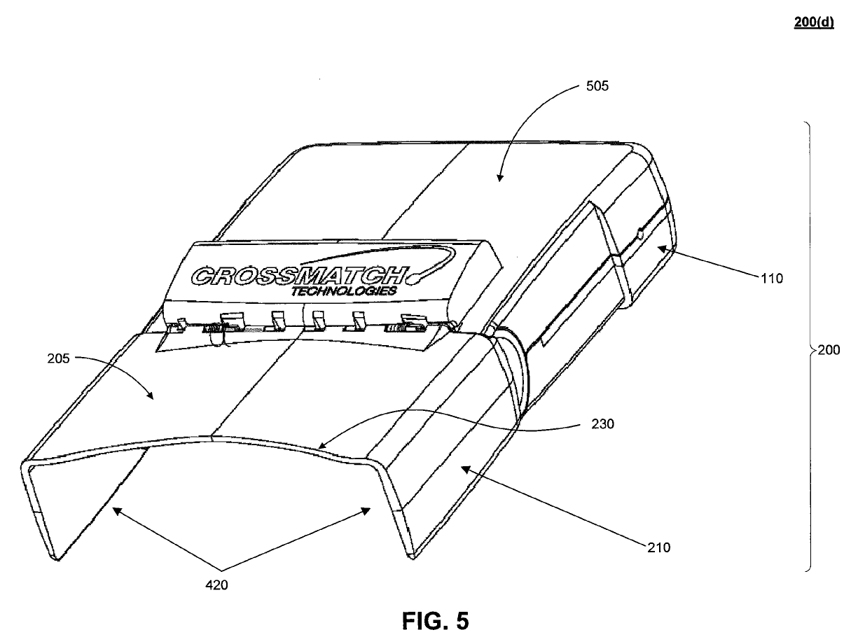

FIG. 5 shows a fourth view 200(d) of exemplary iris scanner 200, already seen in FIG. 2, FIG. 3, and FIG. 4 above. It may be seen that in the open position, a top surface 205 of visor 210 may be substantially parallel to and substantially co-planar with a top surface 505 of scanner housing 110. This may ensure that when a user whose torso and head are substantially in a vertical position places their forehead against a front edge 230 of visor 210, and assuming the scanner is further held in a substantially horizontal position, the user's eyes are at a correct height to be imaged by scanner 200 and are directed at a correct viewing angle to be imaged by scanner 200. It may also be seen that visor 210 has two side panels 420 which may be approximately or substantially parallel to each other, as well being approximately or substantially orthogonal to top surface 205 of visor 210.

### IV. Exemplary Usage

FIG. 6A shows a view 600a of exemplary iris scanner 200 with visor 210 fully extended into the open position, and with the head of a person 610 who is a user of iris scanner 200 positioned at some distance from the forehead receiving edge 230 of visor 210. It may be seen, consistent with the discussion immediately above, that the eyes of person 610 are not at the substantially correct distance from scanner housing 110 for biometric imaging and identification.

However, the eyes of person 610 may be within the field of view of exterior optics 120 of scanner 200. Further, the eyes of person 610 are correctly aligned for biometric imaging and identification, in that the head of person 610 is angled at approximately a right angle to an extended axis running from the front of visor 210 through the back of scanner housing 110, the eyes of person 610 are looking into the front 105 of scanner 200, and the eyes of person 610 are level with scanner 200, this shared level being eye level 620. If person 610 were to grasp scanner 200 with their hands (not illustrated), and pull scanner 200 towards their eyes until visor 210 touched their forehead at approximately the mid-point of the forehead, as indicated by dotted line 630, then person 610 would be at a substantially correct distance from the optics of scanner 200 for effective biometric imaging and identification. This is illustrated in the immediately following FIG. 6B.

FIG. 6B shows a view 600b of exemplary iris scanner 200 with visor 210 fully extended into the open position, and with the head of person 610 who is a user of iris scanner 200 properly positioned against the forehead receiving edge 230 of visor 210. It may be seen, consistent with the discussion above, that the eyes of person 610 are not only within the field of view of scanner optics 120, but further are now at the substantially correct distance from scanner housing 110 for biometric imaging and identification; and further, that the eyes of person 610 are correctly aligned for biometric imaging and identification. Finally, and assuming ambient lighting comes primarily from a light source which is at a height which is at least as high at the height of scanner 200, but preferably from a height which is somewhat higher than the height of scanner 200, both the eyes of person 610 and the exterior optics 120 of iris scanner 200 are shielded or partially shielded from ambient light by visor 210.

FIG. 7 shows a sequence of images 710, 720, 730, and 740 which represent visor 210 being progressively folded closed over time, from starting open position 710 to finished completely closed position 740. Time series 710-740 illustrates that when visor 210 is in the fully closed position (image 740), visor 210 may be neatly tucked away, flush against a surface which may be a bottom surface of iris scanner housing 110.

It may be further seen from time sequence 710-740 that as visor 210 is folded into place under scanner housing 110, visor cap 240 may slide forward off the top surface 505 of scanner housing 110 and into place on the front of scanner housing 110, where visor cap 240 may serve as a cover protecting exterior scanner optics 120. A spring-loaded hinge, discussed further below, serves to hold visor cap 240 flush against top surface 505 of scanner housing 110 when visor 210 is in open position 710, and also serves to hold visor cap 240 flush against front 105 of scanner housing 110 when visor 210 is in closed position 740.

Persons skilled in the relevant art(s) will further appreciate that the time series of images of FIG. 7 may equally well represent a reverse direction of motion, that is, a progression from image 740 to 710, in which case visor 210 starts in a closed position 740 and is progressively opened into an open position 710. The opening and closing of visor 210 is made possible by visor joints 250, while the movement of visor cap 240 is made possible by visor cap hinge 260, also discussed further below.

FIG. 7 further illustrates how the relative angle between visor 210 and scanner housing 110 maybe 180° when visor 210 is in fully open position 710, and may be 0° when visor 210 is in fully closed position 740, and how the relative angle may also assume intermediate values such as approximately 120° or approximately 60° as visor 210 swings through intermediate positions 720, 730, respectively, in relation to scanner housing 110. As will be discussed further below, some positions, such as fully open position 710 or fully closed position 740 may be positions where visor 210 may be locked into position by user 610, or by a technician (not illustrated) who assists user 610.

### V. Exemplary Joints and Hinges

Exemplary visor 210 may be connected to exemplary iris scanner body 110 via two visor joints, such as exemplary visor joints 250 illustrated in FIG. 8A. Visor joints 250 may permit visor 210 to be pivoted through a range of angles in relation to iris scanner housing 110 by the application of a modest torque to visor 210. The range of angles may range from a fully closed position, which may be 0 degrees, to a fully open position, which may be 180 degrees, as illustrated in FIG. 7 already discussed above.

In one embodiment, exemplary iris scanner 200 with a visor may consist of two exemplary visor joints 250a, 250b, one each at corresponding positions on each side of iris scanner housing 110. A joint 250 may consist of a hole 810 on a side of scanner housing 110, along with a corresponding plug 820 on an interior side of a side panel 420 of visor 210. Plug 820 may be a hollow plug, consisting of a raised, substantially circular rim (as illustrated in FIG. 8A), or plug 820 may be a solid plug. Each plug 820 is sized so as to substantially conform to and fit within a matching hole 810 on the side of main scanner housing 110.

Holes 810 may be positioned in close proximity to front 105 of scanner housing 110, while plugs 820 are positioned in close proximity to an end of visor 210 which may attach to scanner housing 110. Scanner housing 110 of exemplary scanner 200 may have extensions or tabs 805 (shown in FIG. 8B), extending forward from scanner housing 110 and providing space for holes 810 as well as notches 830 (discussed further below).

Visor 210 may be constructed so that the distance between plugs 820 is substantially the same as the distance between holes 810. As a result, plugs 820 may be simultaneously situated within holes 810, so that a first plug 820a is situated within a first hole 810a on a first side of scanner 200 to create a first joint 250a, at the same time that a second plug 820b situated within a second hole 810b on a second side of scanner 200 creates a second joint 250b. Note that, due to the particular perspective view in FIG. 8, hole 810b is entirely obscured from view (although its position is suggested by label 810b), and similarly plug 820a is almost completed obscured from view (although its position is indicated by label 820a).

Together, the pair of visor joints 250 function as a hinge enabling visor 210 to remain attached to scanner housing 110, and to swing through a range of angles in relation to scanner housing 110 as already described above.

In an alternative embodiment (not illustrated), a visor joint 250 may consist a plug on a side of the main scanner body and a hole on a matching side panel of the visor, where a plug again fits into a hole, and where the placement of the elements is analogous to that described above for the first embodiment. A plug on the scanner body may fit into a hole on the visor, again creating a joint, with the pair of joints creating a hinge between visor 210 and main scanner housing 110.

As previously discussed, scanner housing 110 and visor 210 may be composed of a material or combination of materials which may be rigid enough to provide the necessary structural sturdiness for scanner housing 110 and visor 210 to operate properly; yet such materials may also have sufficient elasticity so as to bend or flex to support the operation of moving elements such as scanner body/visor joints 250. In particular, the materials used to manufacture scanner housing 110 and visor 210 may be elastic enough to allow visor 210 to be temporarily flexed slightly at the sides, or possibly to allow scanner housing 110 to be temporarily compressed slightly at the sides, to a sufficient degree that visor 210 may be snapped into place on scanner housing 110 during assembly, and possibly further to allow the remove of visor 210 from scanner housing 110 if desired. At the same time, the construction materials may be sufficiently rigid that once visor joints 250 have been established (for example, by setting corresponding plugs 820a, 820b into corresponding holes 810a, 810b, respectively), visor 210 remains attached to scanner housing 110 during the normal course of usage.

Persons skilled in the relevant art(s) will appreciate that the joints 250 described above are exemplary only, and that other joints and/or hinge devices may be used to connect visor 210 with scanner housing 110, and to permit the necessary type and range of relative motion between visor 210 and scanner housing 110, while staying within the scope and spirit of the present invention.

A visor hinge 250 may further consist of a locking element which temporarily locks visor 210 into one of a plurality of fixed angles of connection in relation to the main scanner housing 110. In one embodiment, an exemplary locking element may consist in part of one or more notches 830 on scanner housing 110, where a notch 830 is substantially adjacent to or on the immediate periphery of a visor joint hole 810. An exemplary locking element may further consist in part of one or more locking plugs 840 on an interior surface of a side panel 420 of visor 210, where a locking plug 840 is sized to be of a same size as, or a slightly smaller size than, the size of a notch 830. As visor 210 is rotated through various angles in relation to scanner housing 110, one or more locking plugs 840 may become aligned with one or more notches 830.

Due to the elasticity of the materials of scanner housing 110 and/or visor 210, the one or more aligned locking plugs 840 may slide or snap into place within the empty space within the one or more notches 830, effectively locking visor 210 into a fixed angle in relation to visor housing 110. In particular, the notches 830 and locking plugs 840 may be so configured as to ensure that at least two fixed, locked angles may be established, wherein a first fixed, locked angle is the open position of visor 210 and a second fixed, locked angle is the closed position of visor 210 as already described above in conjunction with FIGS. 2, 3, 5, 6, and 7 above.

In exemplary iris scanner 200 illustrated in FIG. 8A, a first locking element may consist of notches 830a and locking plugs 840a associated with joint 250a, and a second locking element may consist of notches 830b and locking plugs 840b associated with joint 250b. Note that in FIG. 8, locking plugs 840a are entirely obscured from view (although their approximate position is indicated by label 840a), and similarly notches 830b are obscured from view (although their approximate position is indicated by label 830b).

While visor 210 may be locked into one or more fixed positions in relation to scanner housing 110, the materials used for construction of visor 210 and/or scanner housing 110 may be sufficiently elastic that the application of a relatively modest degree of torque to visor 210 is sufficient to dislodge locking plugs 840 from notches 830, thereby dislodging visor 210 from a locked position and enabling visor 210 to again rotate freely in relation to scanner housing 110 about joints 250. The relatively modest degree of torque which may be needed to dislodge locking plugs 840 from notches 830 may be an amount of torque which may be within the typical strength of a typical user 610 of scanner 200, and may be applied by user 610 of scanner 200 when user 610 is holding scanner housing 110 in a first hand and gripping visor 210 with a second hand.

In an alternative embodiment (not illustrated), a locking element may consist of one or more locking plugs on a side of the main scanner housing 110 and one or more notches on a matching side panel 420 of visor 210, where a locking plug again fits into a notch, and where the placement of the elements is analogous to that described above for the first embodiment.

Persons skilled in the relevant art(s) will appreciate that the locking elements described above are exemplary only, and that other locking elements or locking devices may be used to temporarily lock visor 210 at a fixed angle in relation to scanner housing 110, while staying within the scope and spirit of the present invention.

### VI. Exemplary Visor Cap Hinge

Exemplary iris scanner 200 may further consist of a cap 240 attached to visor 210, where when visor 210 is in a closed position, cap 240 may protect the translucent or semitranslucent covering at the front 105 of scanner 200. In embodiments where such a covering is not present, cap 240 may protect exterior optics 120, exterior lighting elements 130, and possibly other exterior elements of scanner 200, and may further help protect both exterior and interior elements of scanner 200 from environmental elements such as moisture, dirt, etc. Cap 240 has already been discussed in part in conjunction with FIGS. 2 through 5, above.

FIG. 9 provides an exploded view of an exemplary cap hinge 910 which may join cap 240 with visor 210. Cap hinge 910 may consist of a first piano-hinge element 920 on an edge of the visor and a second piano hinge element 930 on an edge of cap 240, where the first piano hinge element 920 and second piano hinge element 930 interlock to form hinge 910. One or more torsional springs 940 may be embedded along the elongated axis of hinge 910, either exterior to or interior to hinge elements 920, 930, with spring 940 configured so that spring 940 presses cap 910 closed over the exterior optics 120 when visor 210 is in a closed position, and so that spring 940 presses cap 240 against a top surface 505 of visor 210 when the visor is in the open position.

Cap 240 may have a gasket along its edge, or scanner housing 110 may have a gasket on its exterior surface substantially aligned with an edge of cap 240, so that when cap 240 covers the front end of scanner housing 110, the gasket provides an additional seal against moisture, dirt, and other environmental elements.

FIG. 9 also illustrates the manner in which visor 210 may be joined to housing 110, as indicated by connection lines 250.

### VII. Further Embodiments

In an alternative embodiment consistent with the present system and method, scanner housing 110 may be approximately cuboid in shape; however, one or more surfaces may depart from being substantially planar by being quasiplanar which may entail having an approximately flat surface but varying from being strictly flat by, for example and without limitation:
having a modest degree of curvature;
having modest indents and/or outdents;
having ridges and/or grooves;
having openings of various sizes; or
having other features which serve either functional or ornamental purposes, and which thereby depart from a strictly or substantially planar form.

In an alternative embodiment consistent with the present system and method, pairs of facing surfaces may be approximately parallel. In an alternative embodiment consistent with the present system and method, at least one of the six outer border planes of the substantially cuboid shape or approximately cuboid shape of scanner 200 may not be a solid surface or substantially closed surface of scanner housing 110. Instead, in one embodiment, at least one outer border plane of scanner 200, which may be a front 105 of scanner 200, may instead be defined by structural or functional elements such as lenses, lighting elements, filters (which may, for example, be clear or tinted plating consisting of glass, plastic, or other polymers or materials), and similar functional elements, wherein such elements may be substantially or approximately coplanar, and so define in part or in whole an exterior boundary of scanner 200.

In an alternative embodiment, at least one entire side of the substantially cuboid shape or approximately cuboid shape of scanner 200 may be an open side, possibly a front side 105, which may reveal optical components and other components that are partly or wholly recessed within scanner 200. For example, such an open front side 105 of scanner 200 may reveal lenses, lighting elements, filters, and other imaging elements which are used to establish a field of view for obtaining an image of at least a portion of an eye of a person for biometric identification, and a person using scanner 200 may look into open front side 105 of scanner 200 during the course of using scanner 200.

As noted above, in an alternative embodiment, exemplary iris scanner 200 may have other shapes. For example, scanner 200 could be substantially oval or round scanner housing 110, with a suitable open front side area 105 for exposing exterior optics 120 and exterior illumination 130. A visor 210 with rounded or curved sides, designed to conform to the shape of scanner housing 110, may be attached to such an exemplary scanner 200 via hinge elements 250 similar to those discussed already above.

Exemplary iris scanner 200 may contain additional elements for accepting, focusing, and processing an image of at least part of an eye of a person, or for otherwise enabling scanner 200 to perform its intended functions. Such elements or components (not illustrated in any of the figures) may be contained within scanner housing 110 or may be behind lens or lenses 120 or behind illumination 130 and may include, for example, and without limitation:
power delivery and management components (including, for example and without limitation, batteries, transformers, power regulators, and similar components);
additional optical elements (including, for example and without limitation, lenses, prisms, mirrors, gratings, fiber optics, light-emitting elements, holographic components, and optical filters) for receiving, focusing, steering, filtering, and/or otherwise optically processing an image of the human eye;
image processing elements (including, for example and without limitation, CCDs, CMOS active pixel sensors, amplifiers, DACs, and ADCs) for transforming an image of at least part of an eye of a person, received by the optical elements, to a signal suitable for image processing;
signal processing elements (including, for example and without limitation, a DSP, a microprocessor, and/or memory) for identifying from the obtained signal such physiological features as an iris of a human eye, a retina of the human eye, and possibly other features of the human eye;
information processing elements for identifying a person or persons based on the identified physiological features of a human eye; and
a transmitter or other means to relay information to an external data processing system.

Scanner 100 may also have additional external features, not illustrated, which enable scanner 100 receive power and/or to communicate data to and/or receive data from an external controller such as a personal computer. Such external features may include, for example and without limitation, one or more power connector(s), USB port(s), IEEE 1392 port(s), Ethernet port(s), infrared port(s), serial port(s), parallel port(s), RJ-11, RJ-14, RJ-25, and RJ-45 connector(s), other modular jack(s), and other ports, jacks, and connectors well known in the art.

In embodiments described above, it has been assumed that exemplary visor 210 of exemplary scanner 200 is opaque, in order to shield the eyes of user 610 from ambient light. In an alternative embodiment, visor 210 may be composed of a material or materials which are translucent or semitranslucent. In particular, visor 210 may be composed of a material or materials which permit passage of a color of light or colors of light which do not affect the imaging process, while still blocking a color of light or colors of light which would interfere with the imaging process. An advantage of such an embodiment may be that permitting the passage of some ambient light may induce the pupil(s) of the eye(s) of user 610 to close, resulting in a larger area of the iris to be present for imaging. In an alternative embodiment, visor 610 may be translucent or partly translucent to all colors of light.

Visor 210 has been disclosed above in embodiments with a top surface 205 and two side panels 420, but no bottom. In an alternative embodiment of the present system and method, visor 210 may have a bottom side. With a bottom side component, visor 210 may form an approximately rectangular tube configured to extending from scanner housing 110 to the forehead of user 610. With a bottom side component, visor 210 may be effective in shielding against ambient light which comes from a source which is at or below the height at which scanner 200 is itself used. In one embodiment, a bottom side may be comprised of a detachable panel which may be clipped onto or snapped onto the bottom of side panels 420 of visor 210 when visor 210 is in open position 710.

In an alternative embodiment, a bottom side may be composed of two semi-flexible elements attached to side panels 420 of visor 210. When visor 210 is in the open position 710, the semi-flexible elements may extend and meet each other to form a bottom side which shields from ambient light coming from below. When visor 210 is returned to closed position 740, such elements may fold into place between visor top 205 and side panels 420, and scanner main body 110. Persons skilled in the relevant arts will recognize that other means may exist to create a bottom side component of visor 210 consistent with the present system and method.

The present system and method has been disclosed in relation to embodiments where scanner 200 has optical elements 120, illumination elements 130, and possibly other elements suitable for imaging and scanning two eyes of a user. Moreover, visor 210 as disclosed in embodiments throughout this document approximately spans the full width of a person's forehead.

In an alternative embodiment, scanner 200 may be configured with optical elements 120, illumination elements 130, and possibly other elements suitable for scanning only one eye at a time. In one embodiment, visor 210 may still be configured to span an entire width of a forehead of a person. In an alternative embodiment, visor 210 may be configured to span and to conform to a partial width of a forehead of a person, which may for example be a left side of a forehead, a right side of a forehead, or a center of a forehead.

The present system and method has been disclosed in relation to embodiments wherein visor 210 has a fixed width, and in particular has a fixed width of an end which is configured to accept a forehead of a person. In an alternative embodiment, visor 210 may be configured with an adjustable width, or may be configured with additional elements to adjust a shape or width of a forehead receiving end to be suitable for foreheads of different persons. For example, visor 210 may be supplied with removable, clip-on attachments which are configured to adjust the size or shape of the forehead receiving end for different users. Other means to adjust the shape or width of the forehead receiving end of visor 210 may be envisioned as well.

### VIII. CONCLUSION

The present invention is not limited to the embodiment of an iris scanner. The present invention can be used with any system that utilizes optics for measuring a physiological property of the human eye, such as a retinal scanner. The previous description of exemplary embodiments is provided to enable any person skilled in the relevant art(s) to make or use the present invention. While the invention has been particularly shown and described with reference to exemplary embodiments thereof, it will be understood by those skilled in the relevant art(s) that various changes in form and detail may be made therein without departing from the spirit and scope of the invention.

1. A scanner for determining the identity of a person, comprising:
a main scanner body;
an optical element coupled to main scanner body for obtaining an image of at least a portion of an eye of the person; and
a visor comprising a first end for attaching to the main scanner body and a second end for receiving a head of the person, the second end of the visor having a substantially fixed relative position in relation to the first end;
wherein the substantially fixed relative position of the second end in relation to the first end determines a relative position between the optical system and the eye of the person whose head is positioned at the visor, such that at least a portion of the eye is located in a field of view of the optical system allowing the optical system to obtain an image of at least a portion of the eye.

2. The scanner of claim 1, wherein the substantially fixed relative position of the second end in relation to the first end comprises a length of the visor between the second end and the first end;
wherein the length of the visor determines a distance between the optical system and the eye of the person whose head is positioned at the visor, such that at least a portion of the eye is located at a focal length of the optical system allowing the optical system to obtain an image of at least a portion of the eye.

3. The scanner of claim 1, wherein the second end of the visor is contoured to substantially conform to a shape of a forehead of the head of the person.

4. The scanner of claim 1, wherein the visor further comprises a first surface extending from the first end to the second end, wherein the first surface is shaped to substantially conform to a surface of the main scanner body.

5. The scanner of claim 4, wherein the main scanner body has a shape which is approximately a cuboid.

6. The scanner of claim 5, wherein the first surface is at least one of substantially flat, substantially planar, and quasiplanar.

7. The scanner of claim 5, wherein a length of the visor between the first end and the second end is at least one of substantially the same length as a length of the surface of the main scanner body and a length on the order of half of the length of the surface of the main scanner body.

8. The scanner of claim 5, wherein the first surface of the visor has a width which is substantially the same as a width of the main scanner body.

9. The scanner of claim 8, wherein the visor further comprises two side panels attached to opposite edges of the first surface of the visor and separated by the width of the visor;
wherein each side panel extends from the first end of the visor to the second end of the visor;
wherein each side panel is approximately parallel to the other side panel;
wherein each side panel extends in a common direction approximately orthogonal to the first surface of the visor; and
wherein the visor with the side panels forms a shroud to shield at least one of the eye of the person and an optical system of the scanner from ambient lighting.

10. The scanner of claim 9, wherein the visor further comprises a bottom element configured to shield from an ambient lighting coming from below the scanner.

11. The scanner of claim 10, wherein the bottom element is configured to be attached to the side panels.

12. The scanner of claim 10, wherein the bottom element is configured to be removable.

13. The scanner of claim 1, further comprising a visor hinge attaching the visor to the main scanner body, wherein the visor hinge permits the visor to be pivoted through a range of angles in relation to the main scanner body.

14. The scanner of claim 13, wherein the visor hinge comprises a pair of joints between the visor and the main scanner body.

15. The scanner of claim 14, wherein a joint comprises at least one of:
a hole in a side of the main scanner body and a corresponding plug on a side panel of the visor; and
a plug on the side of the main scanner body and a corresponding hole in the side panel of the visor.

16. The scanner of claim 13, wherein the visor hinge further comprises a locking element for temporarily locking the visor into one of a plurality of fixed angles of connection in relation to the main scanner body.

17. The scanner of claim 16, wherein the locking element is configured to temporarily lock the visor in an angle of approximately one hundred and eighty degrees in relation to the main scanner body;
wherein a first surface of the visor is substantially parallel to a surface of the main scanner body; and
wherein the visor is extended outward from the main scanner body to receive the forehead of the person and to determine a distance between the main scanner body and the head of the person.

18. The scanner of claim 16, wherein the locking element is configured to temporarily lock the visor in an angle of approximately zero degrees in relation to the main scanner body, wherein a first surface of the visor is substantially flush with a surface of the main scanner body.

19. The scanner of claim 16, wherein the plurality of fixed angles determine at least:
an open position of the visor in relation to the main scanner body, wherein the visor is configured to accept the head of the person for scanning; and
a closed position of the visor in relation to the main scanner body, wherein the scanner is in a most compact configuration.

20. The scanner of claim 16, wherein:
the locking element comprises at least one of a notch on the main scanner body or a locking plug on the main scanner body; and
the locking element further comprises at least one of a locking plug on the visor corresponding to the notch on the main scanner body or a notch on the visor corresponding to the locking plug on the main scanner body;
wherein the fixed angle of connection between the visor and the main scanner body is created by at least one of the locking plug on the visor locking into the notch on the main scanner body or the notch on the visor locking into the locking plug on the main scanner body.

21. The scanner of claim 1 further comprising a cap attached to the visor, wherein the cap is configurable to protect an exterior area of the main scanner body.

22. The scanner of claim 21, further comprising a cap hinge coupling the cap to the visor.

23. The scanner of claim 22, wherein the cap hinge comprises:
a first piano-hinge element on an edge of the visor;
a second piano-hinge element on an edge of the cap; and
a torsional spring;
wherein the first piano-hinge element and the second piano-hinge element interlock to form a rotating joint along the edge of the visor; and
wherein said rotating joint is a spring-actuated joint.

24. The scanner of claim 1, further comprising:
a visor hinge which attaches the visor to the main scanner body;
a locking mechanism of the visor hinge configured to create a plurality of fixed angles of connection between the visor and the main scanner body, wherein the fixed angles determine at least one of an open position of the visor in relation to the main scanner body and a closed position of the visor in relation to the main scanner body; and
a cap attached to the visor, wherein the cap covers an exterior area of the scanner when the visor is in the closed position and the cap uncovers the exterior area of the scanner when the visor is in the open position.

25. The scanner of claim 24, further comprising a gasket for protecting the scanner when the visor is in the closed position.

26. The scanner of claim 25, wherein the gasket is at least one of a gasket of the cap or a gasket of the main scanner body, wherein the gasket of the main scanner body is substantially aligned with the cap.

27. The scanner of claim 24, further comprising a cap hinge coupling the cap to the visor.

28. The scanner of claim 27, wherein said cap hinge comprises:
a first piano-hinge element on an edge of the visor;
a second piano-hinge element on an edge of the cap; and
a torsional spring;
wherein the first piano-hinge element and the second piano-hinge element interlock to form a rotating joint along the edge of the visor.
wherein the torsional spring is configured to press the cap closed over the exterior area when the visor is in the closed position; and
wherein the torsional spring is configured to press the cap flush against a surface of the scanner when the visor is in the open position.

29. The scanner of claim 1, wherein said visor further comprises a bottom element for shielding from an ambient lighting coming from below said scanner.

30. The scanner of claim 29, wherein said bottom element is configured to be removable.

31. The scanner of claim 1, wherein the visor is substantially opaque to light.

32. The scanner of claim 1, wherein the visor is configured to be substantially translucent to a first color of light and to be substantially opaque to a second color of light.

33. The scanner of claim 1, wherein the scanner is configured to image at least a portion of a single eye of a person.

34. The scanner of claim 1, wherein the scanner is configured to image at least respective portions of a respective two eyes of a person.

35. The scanner of claim 1, wherein the visor is configured to substantially conform to a fall width of a forehead of the person.

36. The scanner of claim 1, wherein the visor is configured to substantially conform to a partial width of a forehead of the person.

37. The scanner of claim 1, wherein the visor is configured to adjust to a size of a forehead of the person.

38. A system for establishing a relative position between an optical system and the eye of a person comprising a visor with a first end coupled to the optical system and a second end for receiving a forehead of the person, the second end of the visor having a substantially fixed relative position in relation to the first end;
wherein the substantially fixed relative position of the second end in relation to the first end determines a relative position between the optical system and the eye of the person whose head is positioned at the visor, such that at least a portion of the eye is located in a field of view of the optical system allowing the optical system to obtain an image of at least a portion of the eye.

39. The system of claim 38, wherein the substantially fixed relative position of the second end in relation to the first end comprises a length of the visor between the second end and the first end;
wherein the length of the visor determines a distance between the optical system and the eye of the person whose head is positioned at the visor, such that at least a portion of the eye is located at a focal length of the optical system allowing the optical system to obtain an image of at least a portion of the eye.

40. The system of claim 38 further comprising an attaching element, wherein the visor is coupled to the optical system by being attached to the optical system.

41. The system of claim 40, wherein the attaching element comprises a visor hinge.

42. The system of claim 38, wherein the second end of the visor is contoured to substantially conform to a shape of a forehead of the person.

43. The system of claim 38, further comprising a cap attached to the visor, wherein the cap is configured to cover an exterior area of the optical system.

44. The system of claim 38, further comprising a locking element for temporarily locking the visor into a plurality of fixed angles of connection in relation to the optical system.
